(19) United States
(12) Patent Application Publication
(10) Pub. No.: US 2018/0214832 A1
(43) Pub. Date: Aug. 2, 2018

(54) Baby Feeding Bottle with a Whisking Ball

(71) Applicant: Erika Sussi, McCall, ID (US)

(72) Inventor: Erika Sussi, McCall, ID (US)

(21) Appl. No.: 15/419,872

(22) Filed: Jan. 30, 2017

(51) Int. Cl. B01F 13/00; A61J 9/00; A61J 11/04; A61J 11/00; B65D 23/04; B65D 25/56; A61J 11/02; B01F 15/00

(52) U.S. Cl. CPC B01F 13/0052; A61J 9/005; A61J 11/04; A61J 11/008; B65D 23/04; B65D 25/56; B01F 2215/0022; B01F 13/0022; B01F 13/0057; B01F 15/00798; B01F 15/00155; B01F 2015/00084; A61J 11/02

(57) ABSTRACT

A baby feeding container contains a bottle, a whisking ball, a sealing ring, and a liquid outlet. The whisking ball is positioned within the bottle. The liquid outlet is pressed against an opening of the bottle with the sealing ring. The liquid outlet includes a nipple collar and a feeding nipple that ensure the liquid within the bottle flows out of the feeding nipple. If the user intends on measuring the amount of liquid within the bottle, a plurality of quantity markers can be used. Moreover, the whisking ball is insulated in a rubberized coating to minimize any noise generated when the baby formula is mixed in water by shaking the bottle.

### FIELD OF THE INVENTION

The present invention relates generally to baby feeding bottles. More specifically, the present invention introduces a baby feeding bottle with a whisking ball. The present invention allows the parents to conveniently mix the feeding formula prior to feeding the baby.

### BACKGROUND OF THE INVENTION

Baby feeding bottles are a necessity in almost every household with a baby. These bottles are used as an alternative to breast feeding. However, the effort needed to mix the formula with the use of a feeding bottle can be a stressful maneuver for a parent. For example, the baby feeding bottle needs to be shaken vigorously. In another instance, the formula needs to be stirred vigorously to ensure that the formula is appropriately dissolved for the consumption of the baby. Even though existing baby feeding bottles are a good alternative to breast feeding, certain drawbacks of these feeding bottles can be concerning.

Many of the existing baby feeding bottles contain a plurality of interlocking components. When it is required to clean the bottle, each of these interlocking components need to be removed and cleaned individually. The large number of components also provides more surface area for germs. Therefore, thorough cleaning of each of the components is essential. This process can be time consuming and stressful to the parent or caretaker. As a result, there is a need for a baby bottle feeder with a minimum number of components that can be easily disassembled and cleaned is evident.

Another disadvantage with existing baby feeding bottles is the noise generated when mixing the baby formula. As an example, the noise generated can disrupt the sleep of a baby. In another instance, if the baby bottle feeder is used at night, the noise generated can disturb other individuals in the vicinity. Therefore, the need for a bottle that can appropriately mix the baby formula with minimum disturbance is clearly apparent.

The objective of the present invention is to address the aforementioned issues. In order to do so, the present invention introduces a baby feeding bottle with a whisking ball. The whisking ball can be removed from the bottle so that the feeding bottle and the whisking ball can be handled and cleaned independently. Individual cleaning of the components ensures, a majority of the germs are removed prior to being used for feeding.

### BRIEF DESCRIPTION OF THE DRAWINGS

FIG. 1 is a perspective view of the present invention.

FIG. 2 is a front view of the bottle of the present invention.

FIG. 3 is an illustration of the whisking ball used in the present invention.

FIG. 4 is an exploded view of the bottle, the sealing ring, and the feeding nipple.

FIG. 5 is an exploded view of the whisking ball and the bottle, wherein a diameter of the opening is greater than a diameter of the whisking ball.

FIG. 6 is a perspective view of the liquid outlet illustrating the venting hole.

FIG. 7 is a bottom perspective view of the liquid outlet illustrating the venting hole.

### DETAIL DESCRIPTIONS OF THE INVENTION

All illustrations of the drawings are for the purpose of describing selected versions of the present invention and are not intended to limit the scope of the present invention.

The present invention introduces an apparatus that can be used to conveniently mix baby formula to be fed to a baby. More specifically, the present invention introduces a baby feeding bottle that is used with a whisking ball. The whisking ball is positioned inside the baby feeding bottle. Therefore, when the bottle is shaken, the whisking ball helps the baby formula to dissolve in water. By utilizing the present invention, issues such as partial dissolving can be effectively addressed.

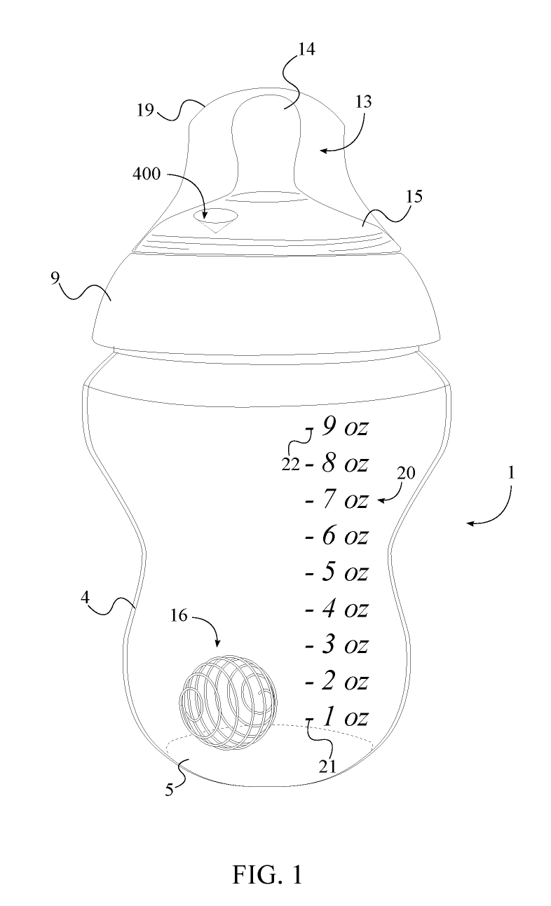

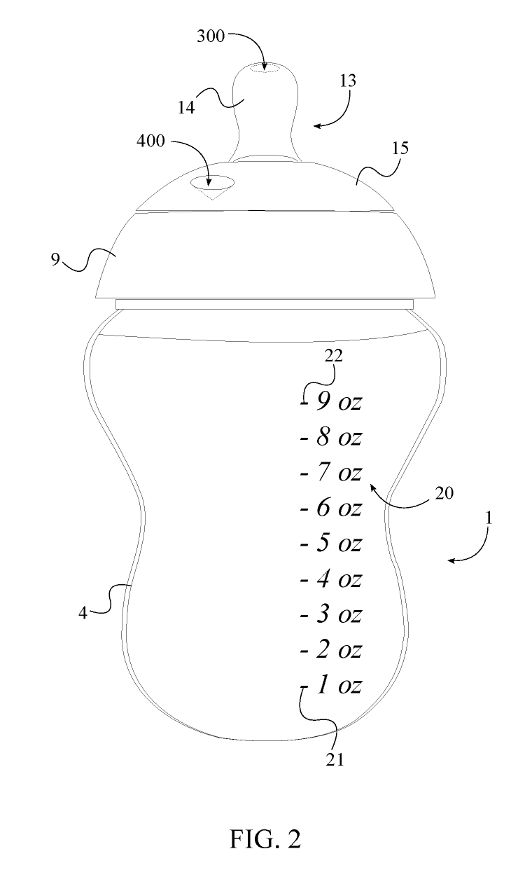

As illustrated in FIG. 1 and FIG. 2, the present invention comprises a bottle 1, a whisking ball 16, a sealing ring 9, and a liquid outlet 13. The bottle 1 is used to hold the water and baby formula mixture that is intended to be fed to the baby. The size, shape and, materialistic properties of the bottle 1 can vary in different embodiments of the present invention. The whisking ball 16 is used to mix the baby formula with water that is held within the bottle 1. In order to do so, the whisking ball 16 is removably positioned within the bottle 1. The liquid outlet 13 is used to draw out the dissolved baby formula from the bottle 1. To provide user convenience, the liquid outlet 13 is produced from a flexible material. The sealing ring 9 holds the liquid outlet 13 against the bottle 1 so that the liquid outlet 13 and the bottle 1 can be handled as a single unit.

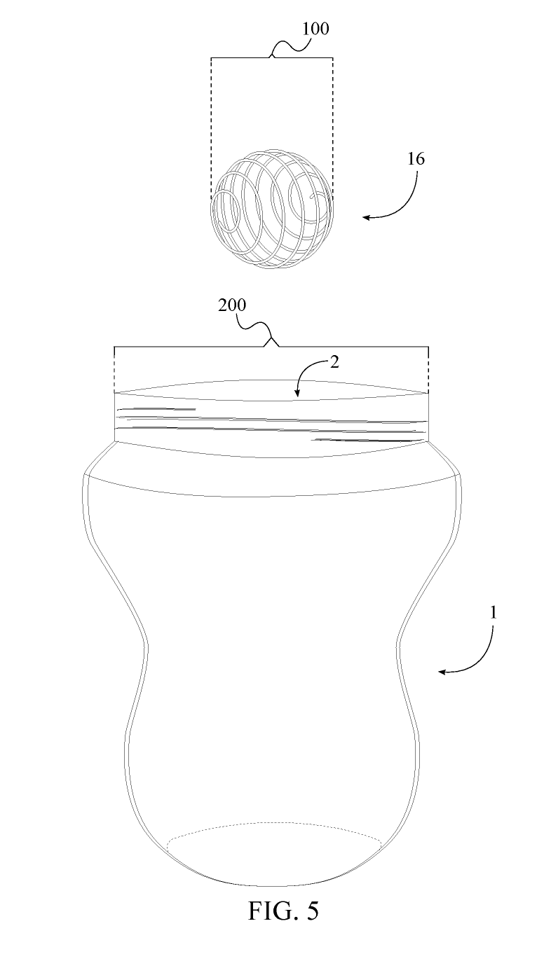

The bottle 1, which is made of a flexible material, comprises an opening 2, a rim 3, a body portion 4, and a base portion 5. The opening 2 which is illustrated in FIG. 5, provides a pathway for the dissolved baby formula to reach the liquid outlet 13. The opening 2 is delineated by the rim 3 which is the topmost edge of the bottle 1. On the other hand, the base portion 5 defines the base level of the bottle 1. The body portion 4 defines the size of the bottle 1, and the size and shape of the bottle 1 can vary in different embodiments of the present invention. When considering the positioning, the opening 2 and the base portion 5 is positioned opposite to each other across the body portion 4. In other words, the body portion 4 extends from the rim 3 towards the base portion 5 determining the overall height of the bottle 1.

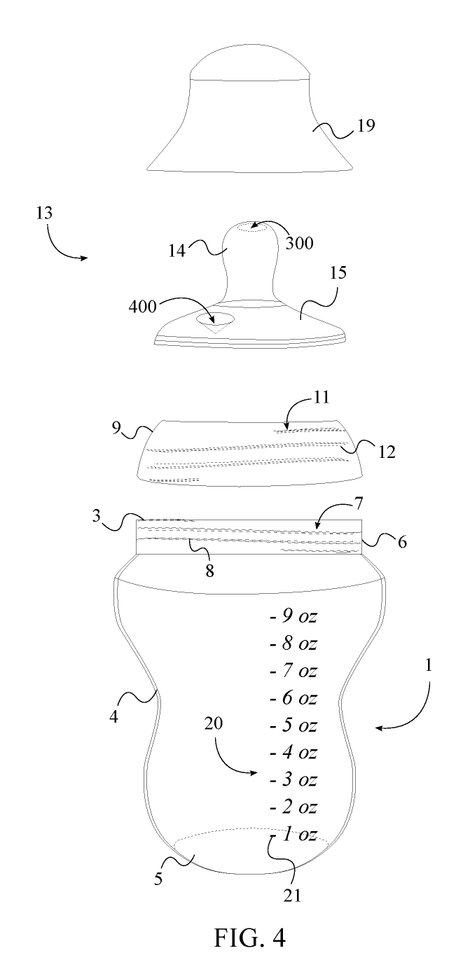

As seen in FIG. 4, in the preferred embodiment of the present invention, the liquid outlet 13 comprises a feeding nipple 14 and a nipple collar 15. When the present invention is in use, the baby draws out the liquid through the feeding nipple 14. The nipple collar 15 is used to establish a connection with the bottle 1. In order to connect with the bottle 1, the liquid outlet 13 is concentrically and removably positioned adjacent to the rim 3 and opposite to the body portion 4. Moreover, the feeding nipple 14 is adjacently connected to the nipple collar 15. As a result, a smooth fluid flow from the bottle 1 to the feeding nipple 14 is maintained through the nipple collar 15.

As seen in FIG. 2, the present invention utilizes a nipple hole 300 as the outlet from the feeding nipple 14. The flow of the baby formula can be controlled by varying the size of the nipple hole 300. As an example, if a baby up to three months in age needs the baby formula to flow at a slow speed, the nipple hole 300 can be considerably small. If a baby six months in age needs the baby formula to flow faster, the nipple hole 300 can be larger. For the baby formula to flow uninterrupted from the bottle 1, the nipple hole 300 perpendicularly traverses through the feeding nipple 14.

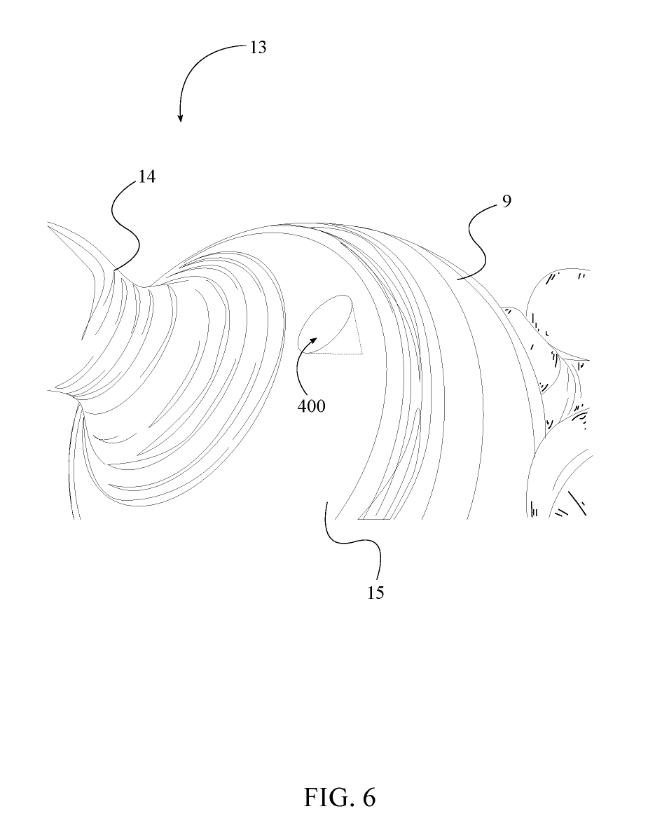

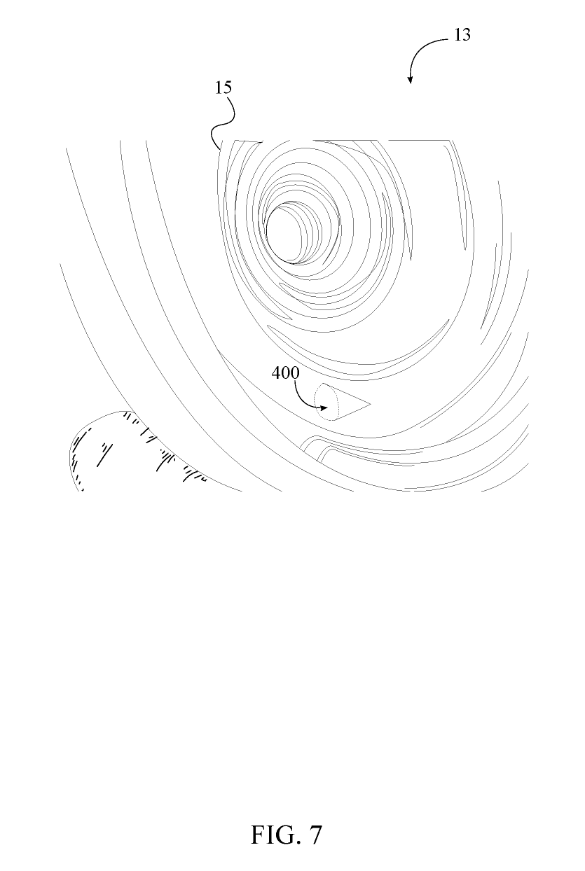

As shown in FIG. 4, FIG. 6, and FIG. 7, the present invention further comprises a venting hole 400 that prevents the formation of air bubbles within the feeding nipple 14. More specifically, the venting hole 400 is used to prevent air from becoming trapped or mixing through the baby formula and swallowed by the baby. The shape and size of the venting hole 400 can vary in different embodiments of the present invention. The venting hole 400 is positioned adjacent the feeding nipple 14 and perpendicularly traverses through the nipple collar 15.

As mentioned before, the sealing ring 9 is used to hold the liquid outlet 13 stationary. In order to do so, the sealing ring 9 is removably attached to the bottle 1 adjacent to the rim 3 and opposite to the body portion 4. More specifically, the sealing ring 9 is removably attached so that the nipple collar 15 is pressed against the rim 3 with the use of the sealing ring 9. In the resulting position of the liquid outlet 13, the feeding nipple 14 protrudes out from the nipple collar 15 opposite to the bottle 1. Therefore, the baby can draw out liquid through the feeding nipple 14 since there is a constant fluid flow from the bottle 1.

The sealing ring 9 can be attached to the bottle 1 differently in various embodiments of the present invention. In the preferred embodiment of the present invention, the sealing ring 9 comprises an inner lateral wall 10 and a ring interlocking mechanism 11, wherein the ring interlocking mechanism 11 is perimetrically distributed along the inner lateral wall 10. In the preferred embodiment of the present invention, the bottle 1 further comprises a neck portion 6 and a neck interlocking mechanism 7. The neck portion 6 acts as an extension of the body portion 4 and is concentrically connected to the body portion 4 opposite to the base portion 5. In particular, the neck portion 6 allows the opening 2 to have a narrower diameter than a diameter of the body portion 4. When considering the positioning, the opening 2 perpendicularly traverses through the neck portion 6 and into the body portion 4. The neck interlocking mechanism 7 is perimetrically and externally distributed along the neck portion 6. Therefore, when the sealing ring 9 is positioned appropriately, the ring interlocking mechanism 11 is removably attached to the neck interlocking mechanism 7. The ring interlocking mechanism 11 and the neck interlocking mechanism 7 can vary in different embodiments of the present invention. As an example, the neck interlocking mechanism 7 is a female threading 8 in the preferred embodiment of the present invention. In order to correspond to the female threading 8, the ring interlocking mechanism 11 is a male threading 12 in the preferred embodiment of the present invention. The ring interlocking mechanism 11 and the neck interlocking mechanism 7 is illustrated in FIG. 4.

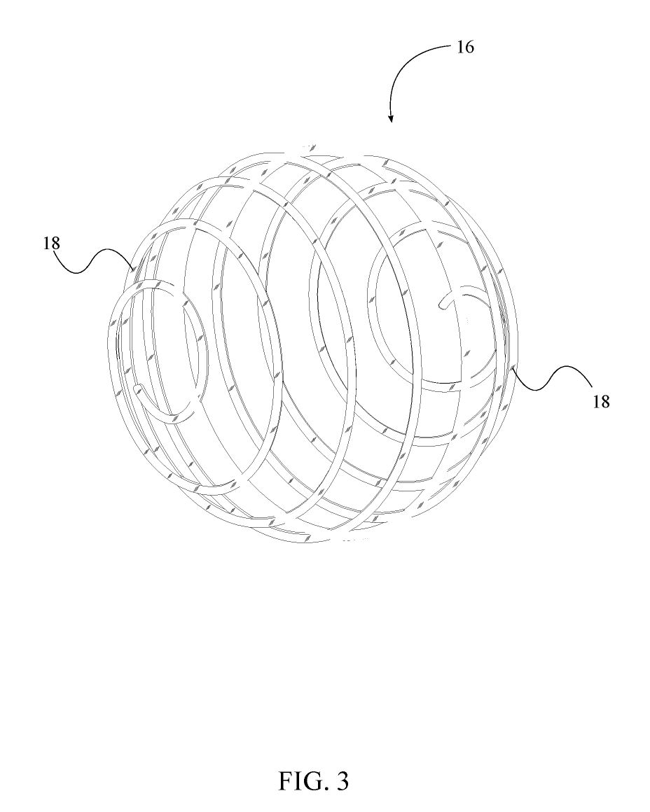

As described earlier, the whisking ball 16 is used in the process of dissolving the baby formula with water or comparable liquid that is filled into the bottle 1. As illustrated in FIG. 5, for the whisking ball 16 to be removably positioned a diameter 200 of the opening 2 is designed to be larger than a diameter 100 of the whisking ball 16. This allows the user to remove the whisking ball 16 from the bottle 1 or place the whisking ball 16 within the bottle 1 as preferred. In order to dissolve the baby formula, the user needs to shake the bottle 1 so that the whisking ball 16 helps stir the baby formula in the water. For better dissolving, the whisking ball 16 needs to be rigid in structure. To provide the required rigidness and to be light-weight, the whisking ball 16 in the preferred embodiment of the present invention is made of stainless steel. However, a different material can be used in another embodiment of the present invention. Shaking the bottle 1 and the whisking ball 16 placed inside the bottle 1 generates noise that can disturb the baby or any other individual in the vicinity. As illustrated in FIG. 3, in the preferred embodiment of the present invention, the whisking ball 16 is insulated with a rubberized coating 18 so that the noise generated when shaking the bottle 1 is eliminated. In other embodiments of the present invention, different insulation methods can be used instead of the rubberized coating 18.

As seen in FIG. 1 and FIG. 4, the present invention further comprises a cap 19. The cap 19 is intended to prevent germs from getting to the feeding nipple 14 and avoid any spillage that can occur when the bottle 1 is moved. The cap 19 is concentrically aligned with the liquid outlet 13 and then removably attached over the feeding nipple 14 so that the user can handle the cap 19 as preferred.

Proper quantities are essential when feeding the baby. As seen in FIG. 2, to fulfill this need, the present invention comprises a plurality of quantity markers 20. Each of the plurality of quantity markers 20 is equidistantly distributed along the body portion 4 so that the user can determine the amount of formula and water that is needed prior to feeding the baby. To provide accurate measurements, a first quantity marker 21 of the plurality of quantity markers 20 is positioned adjacent to the base portion 5. On the other hand, a last quantity marker 22 of the plurality of quantity markers 20 is positioned adjacent to the neck portion 6.

When utilizing the present invention, the following process flow is generally followed. Initially, a required amount of water is poured into the bottle 1 through the opening 2. Next, a required amount of baby formula is put into the bottle 1 through the opening 2. The amount of water poured can be measured with the use of the plurality of quantity markers 20. When the preferred amount of baby formula and water are in the bottle 1, the user presses the liquid outlet 13 against the rim 3 with the use of the sealing ring 9. After the liquid outlet 13 and the sealing ring 9 are appropriately positioned, the cap 19 is removably attached over the feeding nipple 14. Then the user shakes the bottle 1 so that the whisking ball 16 helps dissolve the baby formula in water. When the present invention is in use, the cap 19 is removed so that the baby can draw liquid through the feeding nipple 14. If the user expects to clean the present invention, the sealing ring 9 is initially unfastened so that the liquid outlet 13 and the sealing ring 9 can be detached from the bottle 1. Next, the whisking ball 16 is removed from the bottle 1 so that all components can be cleaned individually.

Although the invention has been explained in relation to its preferred embodiment, it is to be understood that many other possible modifications and variations can be made without departing from the spirit and scope of the invention as hereinafter claimed.

What is claimed is:

1. A baby feeding bottle with a whisking ball comprises:
a bottle;
a whisking ball;
a sealing ring;
a liquid outlet;
the bottle comprises an opening, a rim, a body portion, and a base portion;
the liquid outlet comprises a feeding nipple and a nipple collar;
the opening and the base portion being positioned opposite to each other across the body portion;
the opening being delineated by the rim;
the feeding nipple being adjacently connected to the nipple collar;
the liquid outlet being concentrically and removably positioned adjacent to the rim opposite the body portion;
the sealing ring being removably attached to the bottle adjacent to the rim opposite the body portion, wherein the nipple collar is pressed against the rim by the sealing ring;
the feeding nipple protruding out of the nipple collar opposite to the bottle; and
the whisking ball being removably positioned within the bottle.

2. The baby feeding bottle with a whisking ball as claimed in claim 1, wherein a diameter of the opening is larger than a diameter of the whisking ball.

3. The baby feeding bottle with a whisking ball as claimed in claim 1, wherein the whisking ball being insulated with a rubberized coating.

4. The baby feeding bottle with a whisking ball as claimed in claim 1 further comprises:
a nipple hole; and
the nipple hole perpendicularly traverses through the feeding nipple.

5. The baby feeding bottle with a whisking ball as claimed in claim 1 further comprises:
a venting hole;
the venting hole being positioned adjacent the feeding nipple; and
the venting hole perpendicularly traversing through the nipple collar.

6. The baby feeding bottle with a whisking ball as claimed in claim 1 further comprises:
the sealing ring comprises an inner lateral wall and a ring interlocking mechanism;
the bottle further comprises a neck portion and a neck interlocking mechanism;
the ring interlocking mechanism being perimetrically distributed along the inner lateral wall;
the neck portion being concentrically connected to the body portion opposite the base portion;
the opening perpendicularly traversing through the neck portion and into the body portion;
the neck interlocking mechanism being perimetrically and externally distributed along the neck portion; and
the ring interlocking mechanism being removably attached to the neck interlocking mechanism.

7. The baby feeding bottle with a whisking ball as claimed in claim 6, wherein the neck interlocking mechanism is a female threading.

8. The baby feeding bottle with a whisking ball as claimed in claim 6, wherein the ring interlocking mechanism is a male threading.

9. The baby feeding bottle with a whisking ball as claimed in claim 1 further comprises:
a cap;
the cap being concentrically aligned with the liquid outlet; and
the cap being removably attached over the feeding nipple.

10. The baby feeding bottle with a whisking ball as claimed in claim 1 further comprises:
a plurality of quantity markers;
the plurality of quantity markers being equidistantly distributed along the body portion,
a first quantity marker of the plurality of quantity markers is positioned adjacent to the base portion; and
a last quantity marker of the plurality of quantity markers is positioned adjacent to the neck portion.

11. The baby feeding bottle with a whisking ball as claimed in claim 1, wherein the whisking ball is made of stainless steel.

12. The baby feeding bottle with a whisking ball as claimed in claim 1, wherein the bottle and the liquid outlet are made from a flexible material.
